(19) United States
(12) Patent Application Publication
(10) Pub. No.: US 2022/0190355 A1
(43) Pub. Date: Jun. 16, 2022

(54) SELF-STARTING FUEL CELL WITH INTERCHANGEABLE SOLID CATHODIC OXIDANT

(71) Applicant: BIOSEARCH, LLC, Sarasota, FL (US)

(72) Inventors: Talmadge Kelly Keene, Ruskin, FL (US); Charles E. Entenmann, Key Largo, FL (US); Rebecca Van Orden, North Port, FL (US)

(21) Appl. No.: 17/552,958

(22) Filed: Dec. 16, 2021

Related U.S. Application Data
(60) Provisional application No. 63/126,295, filed on Dec. 16, 2020.

(51) Int. Cl. H01M 4/90; H01M 8/0202

(52) U.S. Cl. CPC H01M 4/9016; H01M 2004/8689; H01M 8/0202

(57) ABSTRACT

A typical fuel cell device that incorporates an anodic hydrogen splitting catalyst, with an electrolytic separator and a cathodic oxidant is provided. In particular, a fuel cell having a separator that can be kept in a dry state because the oxides in the anion section of the fuel cell will combine with the split hydrogen to create water to wet the separator. Additionally, the cathode can be exchanged to allow for reuse of the more expensive anode material.

### CROSS-REFERENCE TO RELATED APPLICATIONS

This application claims the benefit of U.S. Provisional Patent Application No. 63/126,295, filed on Dec. 16, 2020, the entire disclosures of which are hereby incorporated by reference herein

### FIELD OF THE INVENTION

The present invention relates in general to fuel cells and improvements thereto.

### BACKGROUND OF THE INVENTION

Typical fuel cells work by splitting incoming hydrogen gas into electrons and protons. The protons then cross a proton exchange membrane, the electrons travel externally to the fuel cell to do work. The electrons and protons combine, typically, with oxygen on the cathode side. The electrons exit the fuel cell from the anode side and enter the fuel cell on the cathode side. The recombination of electrons, protons and oxygen creates water. There are different types of fuel cells, but this is the basic idea.

Proton exchange membranes (PEMs) are plastic sheets that contain a bound acid component. PEMs must be wet to allow for proton transfer. For a fuel cell to work the PEM must be wetted with liquid water prior to starting the gaseous fuel that produces power from that fuel cell. Once the fuel cell is operational the water created at cathode (combination of electrons, protons, and oxygen) maintains the hydration of the PEM to allow for continuous operation.

The present invention addresses the long-felt need for an improved fuel cell.

### SUMMARY OF THE INVENTION

The invention relates generally to fuel cells with improved capabilities.

While a typical fuel cell device incorporates an anodic hydrogen splitting catalyst, with an electrolytic separator and a cathodic oxidant, in the present invention, the fuel cell having a separator can be kept in a dry state because the oxides in the anion section of the fuel cell will combine with the split hydrogen to create water to wet the separator. Additionally, the cathode can be exchanged to allow for reuse of the more expensive anode material.

Briefly, the invention is directed, in an embodiment, to a fuel cell that creates electricity and has a partially sealed cell with a port to allow for gas to be transmitted to and from the cell; a cathode material composed of solid oxides or a material capable of catalyzing the formation of water from hydrogen and oxygen; an anode material containing a hydrogen gas splitting metal and oxides that will create water upon the addition of hydrogen gas until the oxides are consumed; a dry separator that will not permit the transfer of cations until the separator is wetted by the creating of water from the anode hydrogen combination; and a connector at the anode and cathode to allow for electron transfer out of the cell.

In another embodiment, the present invention is a fuel cell that creates electricity and which has a replaceable cathode composed of a solid metallic oxide material.

In yet another embodiment, the present invention is a fuel cell that creates electricity and which has a replaceable cathode and separator, wherein the replaceable cathode is composed of a solid metallic oxide material and the replaceable separator is composed of a material that will allow the transmission of cations, such as protons.

### DETAILED DESCRIPTION OF PREFERRED EMBODIMENTS

Reference now will be made in detail to the embodiments of the invention, one or more examples of which are set forth below. Each example is provided by way of explanation of the invention, not a limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. The following embodiments and aspects thereof are described and illustrated in conjunction with systems, tools and methods which are meant to be exemplary and illustrative and not limiting in scope. In various embodiments one or more of the above-described problems have been reduced or eliminated while other embodiments are directed to other improvements.

Thus, it is intended that the present invention covers such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

It was discovered using different palladium materials that if the palladium material was an oxide, that these oxides will combine with incoming hydrogen (or isotopes there of) on the anode side of the fuel cell to create water. If a dry electrolyte or PEM (separator) is placed between the anode and cathode of the fuel cell, and the anode is a palladium oxide material it will create sufficient moisture to wet the separator and allow transmission of protons between the anode and cathode section of the fuel cell.

Electric power producing cells were created with a dry electrolytic creating material as the separator, oxide containing or oxide of a hydrogen absorbing material as the anode material, and a metallic oxide as the cathode.

The separators such as PEM, paper, salts (LiF, NaF, ZnF, AlF, NaCl, KCl, LiI), hydroxides (CaOH, LiOH, KOH) can be wetted by the anode under hydrogen creating a cation transferring mechanism.

Anodes may be, but not limited to, lanthanum nickel, titanium, nickel, palladium black, palladium salts (nitrate, chloride, acetate), palladium oxide, palladium on substrate as carbon, copper, and titanium can split hydrogen into protons and electrons. If these anodes are mixed with oxides or are oxides themselves, then the water necessary to allow the separator to transfer cations, is created upon the introduction of hydrogen into the system.

Cathodes may be, but not limited to, solid metal oxides, or oxygen combining catalytic materials if oxygen gas is used as the cathode.

### EXAMPLE

A cell was created with dry calcium oxide as the separator, palladium on carbon (purchased from Alfa Aesar) as the anode material, and solid silver oxide as the cathode. The closed cell was put under vacuum to remove most of the air. The wires connected to the palladium anode and silver oxide created minimal open voltage, but no voltage or current when the cell was put on a high or low resistant load. When hydrogen gas was then introduced into the cell, the open voltage across the 14 mm cell was approximately 1.3V, and on a 10Ω resistor the voltage maintains 400 mV. Calculating the total silver consumed based on the coulomb calculation gave 70-80% conversion of silver II oxide to silver metal. This cell operated at room temperature

During the electric power process silver II oxide is reduced to silver. An electric creating cell can be created with a replaceable cathode section. The separator can be attached to either the anode or cathode. This would create an economically feasible solid oxide cathode hydrogen splitting fuel cell.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged in whole or in part. Furthermore, those of ordinary skill in the art will appreciate that the foregoing description is by way of example only, and is not intended to limit the invention so further described in such appended claims. Therefore, the spirit and scope of the appended claims should not be limited to the description of the versions contained therein.

What is claimed is:

1. A fuel cell for creating electricity comprising:
a. a partially sealed cell with a port to allow for gas to be transmitted to and from the cell;
b. a cathode material composed of solid oxides or a material capable of catalyzing the formation of water from hydrogen and oxygen;
c. an anode material containing a hydrogen gas splitting metal and oxides that will create water upon the addition of hydrogen gas until the oxides are consumed
d. a dry separator that will not permit the transfer of cations until the separator is wetted by the creating of water from the anode hydrogen combination; and
e. a connector at the anode and cathode to allow for electron transfer out of the cell.

2. In a fuel cell for creating electricity, the improvement comprising a replaceable cathode comprised of a solid metallic oxide material.

3. In a fuel cell for creating electricity, the improvement comprising a replaceable cathode and a replaceable separator, wherein the replaceable cathode comprises a solid metallic oxide material and the replaceable separator comprises a material that will allow the transmission of cations.

4. The fuel cell of claim 3 wherein the cations are protons.
